(19) United States
(12) Patent Application Publication
(10) Pub. No.: US 2023/0039720 A1
(43) Pub. Date: Feb. 9, 2023

(54) TREATED BACKER ROD

(71) Applicant: GREENZONE PEST INNOVATIONS PTY LTD, Moorabbin VIC (AU)

(72) Inventor: Paul Anthony Commerford, Moorabbin (AU)

(21) Appl. No.: 17/814,386

(22) Filed: Jul. 22, 2022

(30) Foreign Application Priority Data
Jul. 23, 2021 (AU) 2021104470

(51) Int. Cl. E04B 1/72; A01M 1/24

(52) U.S. Cl. CPC E04B 1/72; A01M 1/245; A01M 2200/011

(57) ABSTRACT

The present application relates to a backer rod for sealing a void. The backer rod comprises an extruded polymer foam composed of crosslinked linear low density polyethylene and poly(ethylene-vinyl acetate) and contains an insecticide. Exemplar insecticides include termiticides such as bifenthrin, permethrin, deltamethrin, lambda-cyhalothrin, cypermethrin, alpha-cypermethrin, zeta-cypermethrin, tetramethrin, and cyfluthrin. The backer rod may be used as physical and chemical barrier to prevent the ingress of insects into a structure.

### FIELD

The present disclosure generally relates to a treated backer rod for controlling and/or repelling against insects. In particular, the present disclosure relates to a treated backer rod containing an insecticide such that the treated backer rod acts as a physical and chemical barrier to impede the ingress of insects into a structure.

### BACKGROUND

Buildings and other structures are susceptible to entry by insects. Some insects, can be attracted by potential sources of food or water and can cause damage to food stuffs or spread diseases to humans including salmonella and gastroenteritis. Crawling insects may enter buildings and other structures through gaps between constructions elements.

Physical barriers have been employed to guard against the entry of insects. For example, caulk compounds are flexible sealing compounds used to close up gaps between constructions elements in buildings and other structures to prevent the entry of water, air, dust, insects, or as a component in fire stopping.

Backer rods are flexible foams which have typically been used to seal gaps or voids in between construction elements of buildings and other structures. They are typically inserted into construction joints prior to caulking to increase elasticity, reduce consumption, force the caulking into contact with the sides of the joint creating a better bond, determine the thickness of the caulking, and define the cross-section hour-glass shape of the caulk.

Installation of backer rods is generally a three-step process, requiring hiring of a builder or tradesperson to (i) installing/inserting the backer rod into a void; (ii) sealing the gap between the backer rod and the top surface of the construction joint; and (iii) surface spraying of insecticides to control ingress of insects, particularly crawling insects. The insecticide is often applied as a liquid spray or paint so that the surface is effectively covered with the substance. A licensed pest controller may be required to apply the insecticide and this is a cost to the building or structure owner.

There is a need for alternative or improved backer rods, that can provide various desirable properties such as insulation, fire resistance and flame stopping, and/or control or repel against insects.

### SUMMARY

The present inventors have surprisingly found that a treated backer rod containing insecticide may control and/or repel against insects. A backer rod comprising a polymeric foam containing at least one insecticide in an effective amount substantially distributed throughout the polymeric foam can advantageously act as a physical and chemical barrier to impede the ingress of insects into a building structure.

In one aspect, there is provided a backer rod for sealing a void formed by a first and second element, wherein the first and second element is defined by a first and second end surface, wherein the first end surface and the second end surface are opposing and adjacent to define the void, the height of the void defined by a top plane and a bottom plane, the backer rod comprising a polymeric foam containing at least one insecticide in an effective amount substantially distributed throughout the polymeric foam, wherein the backer rod acts as a physical and chemical barrier to impede the ingress of insects into a structure, wherein the backer rod is an elongated rod that has a diameter of between about 6 mm to about 65 mm, and wherein the backer rod has a cross-sectional profile that is circular, triangular, square, rectangular or half circular.

In an embodiment, the insecticide may be selected from any one or more of the group comprising pyrethrum, synthetic pyrethroids, organo-chlorines, organo-sulfurs, carbamates, organo-phosphates, formamidines, neonicotinoids, nicotinoids, spinosyns, phenylpyrazoles, pyrroles, pyrazoles, dinitrophenols, pyridazinones, quinazolines, and benzoylureas.

In an embodiment, the concentration of the insecticide may be between about 0.2 wt. %, and about 4.0 wt. %, preferably between about 0.5 wt. % and about 2.0 wt. %.

In an embodiment, the polymeric foam may be a composite comprising crosslinked LLDPE and low melting EVA polymer.

In an embodiment, the polymeric foam may have a density of between about 10 kg/m³ and about 60 kg/m³.

Another aspect relates to a method for sealing a void formed by a first and second element, wherein the first and second element is defined by a first and second end surface, wherein the first end surface and the second end surface are opposing and adjacent to define the void, the height of the void defined by a top plane and a bottom plane, the method comprising the steps of: i) friction fitting a backer rod into the void to a depth to define a sealant collection cavity within the void; and ii) optionally applying a sealant within the sealant collection cavity to form a sealant layer; wherein the backer rod comprises a polymeric foam containing at least one insecticide substantially distributed throughout the polymeric foam, wherein the backer rod acts as a physical and chemical barrier to impede the ingress of insects into a structure, wherein the backer rod is an elongated rod that has a diameter of between about 6 mm to about 65 mm, and wherein the backer rod has a cross-sectional profile that is circular, triangular, square, rectangular or half circular.

### BRIEF DESCRIPTION OF THE DRAWINGS

Some embodiments of the present disclosure are described and illustrated herein, by way of example only, with reference to the accompanying Figures in which:

FIGS. 1a and 1b are images showing application of a treated backer rod around window and door frames.

FIG. 2 is an image showing application of a treated backer rod around a window frame.

FIG. 3a is an image showing application of a treated backer rod in slab on ground.

FIG. 3b is an image showing application of a treated backer rod in a wall.

FIG. 4a is a cross-sectional view of a backer rod as partially installed in an construction application.

FIG. 4b is cross-sectional view of a backer rod showing the diameter of the tube.

FIG. 4c is a cross-sectional view of a backer rod as installed in an construction application.

### DETAILED DESCRIPTION

The present disclosure describes the following various non-limiting examples, which relate to investigations undertaken to identify alternative and improved backer rods, that can provide various desirable properties such as control or repel against insects. The present inventors have surprisingly found that a treated backer rod containing insecticide may control and/or repel against insects. A backer rod comprising a polymeric foam containing at least one insecticide in an effective amount substantially distributed throughout the polymeric foam can advantageously act as a physical and chemical barrier to impede the ingress of insects into a building structure. The insect species may include, for example, cockroaches, ants, spiders, fleas, flies, mosquitoes, and silverfish. In a particular example, the insect may be a cockroach and/or an ant.

### General Definitions and Terms

In the following description, reference is made to the accompanying drawings which form a part hereof, and which is shown, by way of illustration, several embodiments. It is understood that other embodiments may be utilised and structural changes may be made without departing from the scope of the present disclosure.

With regards to the definitions provided herein, unless stated otherwise, or implicit from context, the defined terms and phrases include the provided meanings. In addition, unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

All publications discussed and/or referenced herein are incorporated herein in their entirety.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, compositions, coatings, processes, and coated substrates, referred to or indicated in this specification, individually or collectively, and any and all combinations or any two or more of said steps or features.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, and 5, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification, the term “consisting essentially of”, or variations such as “consisting of” or “consist of”, is intended to exclude elements which would materially affect the properties of the claimed composition.

The terms “comprising”, “comprise” and “comprises” herein are intended to be optionally substitutable with the terms “consisting essentially of”, “consist essentially of”, “consists essentially of”, “consisting of”, “consist of” and “consists of”, respectively, in every instance.

Herein the term “about” encompasses a 10% tolerance in any value or values connected to the term.

As used herein “curable” or “cured” is descriptive of a material or composition that has or can be cured (e.g., polymerised or crosslinked) by heating to induce polymerisation and/or crosslinking; irradiating with actinic irradiation to induce polymerisation and/or crosslinking; and/or which may self-cure through exposure to air, such as by autoxidation; and/or by mixing one or more components to induce polymerisation and/or crosslinking and which may then crosslink or cure under ambient conditions or by baking. “Mixing” can be performed, for example, by combining two or more parts and mixing to form a homogeneous composition. Alternatively, two or more parts can be provided as separate layers that intermix (e.g., spontaneously or upon application of shear stress) at the interface to initiate polymerization.

Herein “weight %” may be abbreviated to as “wt %”.

### Backer Rod Composition and Structure

The present disclosure is directed to providing improvements in backer rods for construction application. The inventors have found that a backer rod containing an effective amount of an insecticide provides a treated backer rod capable of controlling and/or repelling ingress of insects. The insect species may include, for example, cockroaches, ants, spiders, fleas, flies, mosquitoes, and silverfish. In a particular example, the insect may be a cockroach and/or an ant.

In an embodiment, the present disclosure provides a backer rod for sealing a void formed by a first and second element, wherein the first and second element is defined by a first and second end surface, wherein the first end surface and the second end surface are opposing and adjacent to define the void, the height of the void defined by a top plane and a bottom plane, the backer rod comprising a polymeric foam containing at least one insecticide in an effective amount and substantially distributed throughout the polymeric foam, wherein the backer rod acts as a physical and chemical barrier to impede the ingress of insects into a structure, wherein the backer rod is an elongated rod that has a diameter of between about 6 mm to about 65 mm, and wherein the backer rod has a cross-sectional profile that is circular, triangular, square, rectangular or half circular.

In an embodiment, the concentration of insecticide may be between about 0.2 wt. % and about 4.0 wt. %. The concentration of insecticide may be between about 0.5 wt. % and about 2.0 wt. %. The concentration of insecticide may be less than about 4, 3.5, 3, 2.5, 2, 1.5, 1, 0.5, or 0.2. The concentration of insecticide may be at least about 0.2, 0.5, 1, 1.5, 2, 2.5, 3, 3.5, or 4. The concentration of insecticide may be in a range provided by any two of these upper and/or lower values.

In an embodiment, the backer rod may have a cross-sectional profile that is circular, triangular, square, rectangular or half circular. For example, the cross-sectional profile may be circular, triangular, square, or half circular. In a preferred example, the cross-sectional profile may be circular.

In an embodiment, the backer rod is an elongated rod that may have a diameter of between about 6 mm to about 65 mm. The diameter of the backer rod may be in the range of about 10 mm to about 50 mm. The diameter (mm) of the backer rod may be less than about 65, 60, 55, 50, 45, 40, 35, 30, 25, 20, 15, 10, or 6. The diameter (mm) of the backer rod may be at least about 6, 10, 15, 20, 25, 30, 35, 40, 45, 50, 55, 60, or 75. The diameter of the backer rod may be in a range provided by any two of these upper and/or lower values. For example, the backer rod may have a diameter between about 10 mm and 15 mm, or may have a diameter of about 20 mm.

In an embodiment, the backer rod is an elongated rod that may be sold in a length of between about 5 m to about 300 m. The length of the backer rod may be in the range of about 20 m to about 150 m. The length (m) of the backer rod may be less than about 300, 200, 150, 100, 80, 60, 50, 40, 30, 20, 10, or 5. The length (m) of the backer rod may be at least about 5, 10, 20, 30, 40, 50, 60, 80, 100, 150, 200, or 300. The length of the backer rod may be in a range provided by any two of these upper and/or lower values.

In an embodiment, the density of the backer rod may be in a range of between about 10 kg/m³ to about 60 kg/m³. The backer rod may have a density of between 20 kg/m³ to about 50 kg/m³. The density (kg/m³) of the backer rod may be less than about 60, 55, 50, 45, 40, 35, 30, 25, 20, 15, or 10. The density (kg/m³) of the backer rod may be at least about 10, 15, 20, 25, 30, 35, 40, 45, 50, 55, or 60. The density of the backer rod may be in a range provided by any two of these upper and/or lower values. For example, the backer rod may have a density in a range between about 20 kg/m³ and 30 kg/m³, or may have a density in a range between about 40 kg/m³ and 50 kg/m³. Density tests may be performed in accordance with industry standards ASTM D 1622.

In an embodiment, the backer rod may have a compression recovery (%) of at least about 80, 85, 90, 95 or 99. For example, the backer rod may have compression recovery of at least 95%. Compression recovery tests may be performed in accordance with industry standards ASTM D 5249.

In an embodiment, the backer rod may have a tensile strength (kPa) of at least about 200, 210, 220, 230, 240, 250, 260, 270, 280, 290, 300, 310, 320, 330, 340, 350, 360, 380, 390, or 400. For example, the backer rod may have tensile strength of at least 240 kPa. Tensile strength tests may be performed in accordance with industry standards ASTM D 3575.

The present disclosure provides a backer rod that serves several purposes in a construction application. The backer rod may be adapted to provide sealant depth control, while at the same time providing insulation, optional industry standard fire resistance, and impede the ingress of insects. It will be appreciated that the backer rod as described herein may be used in a number of applications, such as, but not limited to, bathroom and kitchen applications; window and door applications; glazing installations; expansion joints; curtain wall joints; partitions; log construction; pavement joints and repairs; re-cast units and copings.

In an embodiment, the backer rod may provide insulation in accordance with ASTM E1966 or ANSI/UL 2079. In an embodiment, the backer rod may form a fire resistant barrier. In an embodiment, the fire retardant extruded with the polymeric foam may any fire retardant known in the art. For example, the fire retardant extruded with the polymeric foam may be antimony trioxide. Fire tests may be performed in accordance with industry standards generate a 450 degree temperature exposure within 5 minutes after the start of a test. Present and accepted industry testing requirements for fire resistance are detailed in (1) ASTM E1966 Standard Test Method for Fire-Resistive Joint Systems and (2) ANSI/UL 2079 Tests for Fire Resistance of Building Joint System). In other words, fire resistant rated joints between construction elements require a more substantial insulation barrier at elevated temperatures.

### Polymeric Foam

The polymeric foam may be manufactured from at least one polymer selected from the group comprising polyamide, polyvinylchloride, polyethylene, polystyrene, synthetic rubber, polymethacrylate, polypropylene, ethylene-vinyl acetate (EVA) polymer and polyurethane. The polymeric foam may be manufactured primarily of polyethylene, a low density polyethylene. For example, the polymeric foam may be a linear low density polyethylene (LLDPE). In a preferred example, the polymeric foam may be a crosslinked LLDPE.

It has been also been found that the temperature of the extrusion step can be controlled by the addition of a quantity of a secondary polymer. For example, the extrusion temperature can be kept below approximately 180° C. by adding a quantity of low melting ethylene-vinyl acetate (EVA) copolymer. The addition of low melting EVA has also been found to help in the dispersion and melt mixing of the polymer and the insecticide.

In one preferred embodiment, the polymeric foam is a composite comprising LLDPE and low melting EVA polymer.

In an embodiment, the polymeric foam may comprise primarily of linear low density polyethylene (LLPDE) or polypropylene, the foam may be open cell, closed cell, contain both open and closed cells, or may be formed as a plurality of coalesced strands or profiles depending on the needs of the application. For example, the polymeric foam may be a closed cell LLPDE with a cell size of between about 0.0.1 mm to about 5 mm. For example, the polymeric foam may have a cell size from about 0.5 mm to about 2 mm. The cell size (mm) of the polymeric foam may be less than about 5, 4, 3, 2, 1.8, 1.6, 1.4, 1.2, 1, 0.5, 0.1, 0.05, or 0.01. The cell size (mm) of the polymeric foam may be at least about 0.01, 0.05, 0.1, 0.5, 1, 1.2, 1.4, 1.6, 1.8, 2, 3, 4, or 5. The cell size of the polymeric foam may be in a range provided by any two of these upper and/or lower values.

In one embodiment, the polymeric foam may have a density of between about 10 kg/m³ to 60 kg/m³. For example, the polymeric foam may have a density of between 20 kg/m³ to 50 kg/m³. The density (kg/m³) of the polymeric foam may be less than about 60, 55, 50, 45, 40, 35, 30, 25, 20, 15, or 10. The density (kg/m³) of the polymeric foam may be at least about 10, 15, 20, 25, 30, 35, 40, 45, 50, 55, or 60. The density of the polymeric foam may be in a range provided by any two of these upper and/or lower values. For example, the polymeric foam may have a density in a range between about 20 kg/m³ and 30 kg/m³, or may have a density in a range between about 40 kg/m³ and 50 kg/m³. Density tests may be performed in accordance with industry standards ASTM D 1622.

In an embodiment, the polymeric foam may have a tear strength (kPa) of at least about 200, 210, 220, 230, 240, 250, 260, 270, 280, 290, 300, 310, 320, 330, 340, 350, 360, 380, 390, or 400. For example, the polymeric foam may have tear strength of at least 240 kPa.

In an embodiment, the polymeric foam may have a tensile strength (kPa) of at least about 200, 210, 220, 230, 240, 250, 260, 270, 280, 290, 300, 310, 320, 330, 340, 350, 360, 380, 390, or 400. For example, the polymeric foam may have tensile strength of at least 240 kPa. Tensile strength tests may be performed in accordance with industry standards ASTM D 3575.

### Insecticide

The present inventors have surprisingly found that the addition of an insecticide extracted with the polymeric foam is capable of controlling and/or repelling insects. For example, the insecticide exhibits control or repellent affects against insects when provided in an effective amount and substantially distributed throughout the polymeric foam. The insect species may include, for example, cockroaches, ants, spiders, fleas, flies, mosquitoes, and silverfish. In a particular example, the insect may be a cockroach and/or an ant.

In an embodiment, the insecticide may be extruded with the polymeric foam.

The insecticide may be any active agent that exhibits control or repellent affects against insect species.

The insecticide may also be non-repellents such as the neonicotinoid (e.g. imidacloprid), phenylpyrazole (e.g. fipronil), and naturally occurring substances, such as those found in termite resistant trees, such as those found in Red Gum trees, Eucalyptus camaldulensis.

The insecticide(s) which is extruded with the polymeric material may be any active agent that exhibits control or repellent affects against insect species. The active agent(s) may include, but are not limited to, pyrethrum, synthetic pyrethroids, organochlorines, organosulfurs, carbamates, organophosphates, formamidines, neonicotinoids, nicotinoids, spinosyns, phenylpyrazoles, pyrroles, pyrazoles, dinitrophenols, pyridazinones, quinazolines, and benzoylureas. Preferably, a noted termiticide is used such as bifenthrin, permethrin, deltamethrin, lambda-cyhalothrin, cypermethrin, alpha-cypermethrin, zeta-cypermethrin, tetramethrin, and cyfluthrin.

The term “pyrethrum” as used herein means pyrethrin compounds derived from chrysanthemum plants, or the same or similar compounds derived from other natural sources, and pyrethroid compounds manufactured synthetically. Specific examples of such compounds include, but are not limited to, deltamethrin, permethrin, cypermethrin, bifenthrin, cyfluthrin, cyhalothrin, tefluthrin, resmethrin, allethrin, kadethrin, sanmarton, fenvalerate, esfenvalerate, lambda-cyhalothrin, tralomethrin, fenpropathrin, tetramethrin, as well as mixtures thereof. These compounds may be extracted from plant sources or may be prepared by a suitable chemical process, and are commercially available from such sources as AgrEvo, Zeneca, Bayer, FMC Corporation, and Aldrich Chemical. Preferably, the compound is a pyrethroid compound selected from deltamethrin, permethrin, bifenthrin, and mixtures thereof. In a particular embodiment, the insecticide bifenthrin is used. Bifenthrin has a non-alpha-cyano molecular structure which renders it a dermal non-sensitiser, i.e. does not react substantially with a person's skin.

The pyrethrum and synthetic pyrethroid family of compounds have very effective surface contact insect repellence, which is important to the prevention of insect attack to any foam products which contains them. The thermal and chemical stability and structure of pyrethrum and synthetic pyrethroid compounds adds to their suitability in plastic manufacturing processes. After manufacture, many pyrethrum and synthetic pyrethroid compounds remain encapsulated in the foam plastic resin because of their chemical structure and relatively low vapour pressure. As a result, the pyrethrum and synthetic pyrethroid compounds provide long-term protection against insect borings that could affect the physical properties of the foam. The concentration of pyrethrum and synthetic pyrethroid compounds in the foam that provides the desired efficacy depends on the specific material used and the targeted insect.

In an embodiment, the insecticide may be a synthetic pyrethroid compound selected from the group comprising deltamethrin, permethrin, bifenthrin, and mixtures thereof. The at least one insecticide may be a termiticide. For example, the insecticide is bifenthrin.

In general, the insecticide, in particular the pyrethrum and synthetic pyrethroid compounds are preferably employed in a cumulative amount. For example, during the preparation of the masterbatch the insecticide, for example bifenthrin, is added at a concentration (wt. %) of the polymer of between approximately 10 to 20 wt. %. Preferably, the percentage bifenthrin in the masterbatch is 20 wt. %. Upon extrusion and foaming, the eventual concentration of the bifenthrin in the foam may be between about 0.2 to 4 wt. %.

In an embodiment, the concentration of insecticide may be between about 0.2 wt. % and about 4.0 wt. %. the concentration of insecticide may be between about 0.5 wt. % and about 2.0 wt. %. The concentration of insecticide may be less than about 4, 3.5, 3, 2.5, 2, 1.5, 1, 0.5, or 0.2. The concentration of insecticide may be at least about 0.2, 0.5, 1, 1.5, 2, 2.5, 3, 3.5, or 4. The concentration of insecticide may be in a range provided by any two of these upper and/or lower values. In one embodiment, the insecticide, e.g. bifenthrin, may be added as 0.2 wt. %, 0.5 wt. %, 1 wt. %, or 2 wt. % of the polymeric foam. The exact concentration used may depend on the type of backer rod, targeted insect and the climatic conditions. The inclusion of bifenthrin in the polymeric foam provides a repellent barrier as well as a chemical barrier to the penetration of insects.

The insecticide(s) may be dispersed, preferably evenly, substantially throughout the polymer matrix of the expansion foam. For example, bifenthrin may be introduced in a powder form and incorporated into the LLPE-EVA resin masterbatch. Depending on the product, the active agent could be added as granules, powder form or liquid to be incorporated into the polymeric foam. Preferably, the insecticide does not leach from the polymeric foam.

### Optional Additives

The polymeric foam may further comprise one or more additives selected from the group comprising inorganic fillers, pigments, stabilizers, antioxidants, antifungal agents, acid scavengers, ultraviolet absorbers, flame retardants, processing aids, dispersion aids, extrusion aids, and the like.

In addition, other additives with insecticidal repellent and/or synergistic properties, such as piperonyl butoxide, may be added to the foamable polymer composition prior to foaming, or may be applied to the exterior portion of the foam sheet in a post-treatment process.

For example, a stabilising agent may be present in the polymeric foam. The stabilizing agent may be selected from any one or more of inorganic silicate, silicone dioxide, hydrophobic silicone dioxide, montmorillonite clay, sodium bentonite clay with high montmorillonite content, kaolin, kaolinite, magnesium aluminium silicate and aluminium silicate.

The stabilizing agent may be a high surface area inorganic silicate, preferably a high surface area aluminium silicate, for example, kaolin. During the extrusion of the masterbatch, kaolin may be added as a high surface area support for bifenthrin and as a stabilizing agent. Also during the foaming process, a food grade wax may be added as a processing aid.

In an embodiment, a stabilizing agent may be present in the polymeric foam in an amount of between about 0.1 wt. %. and about 10 wt. %. The stabilizing agent may be in an amount (wt. %) of less than about 10, 8, 6, 4, 2, 1, 0.5, or 0.1. The stabilizing agent may be in an amount (wt. %) of at least about 0.1, 0.5, 1, 2, 4, 6, 8, or 10. The stabilizing agent may be in a range provided by any two of these upper and/or lower values.

The polymeric foam may also contain a UV stabilizer/UV absorbers to prevent break down of the backer rod when exposed to sunlight. This is important in maintaining the longevity of the backer rod which may be in place for extended periods of time

Pigment may be added to the polymeric composition prior to foaming to give the polymeric foam a specific colour. In an embodiment, the polymeric foam may be a black, grey, blue, brown, green, yellow, silver, orange, red, or natural colour. In a particular example, the polymeric foam may be green. This is an important feature of the invention as it will provide a visual aid to workers to distinguish backer rods which contain an insecticide.

It will be appreciated that a nucleating agent may be added to the polymeric foam to reduce the primary cell size. In an embodiment, the nucleating agent may be an inorganic substance such as hydrated magnesium silicate (talc), calcium carbonate, calcium silicate, indigo, talc, clay, titanium dioxide, silica, calcium stearate, diatomaceous earth, mixtures of citric acid and sodium bicarbonate, and the like. The amount of nucleating agent added may range from about 0.01 to about 5 parts by weight per hundred parts by weight of a polymer resin. For example, the amount of nucleating agent may range from 0.1 to about 3 parts by weight. The average cell size may be in a range between about 0.0.1 mm to about 5 mm. For example, the average cell size may be in a range between about 0.5 mm to about 2 mm. The average cell size (mm) may be less than about 5, 4, 3, 2, 1.8, 1.6, 1.4, 1.2, 1, 0.5, 0.1, 0.05, or 0.01. The average cell size (mm) may be at least about 0.01, 0.05, 0.1, 0.5, 1, 1.2, 1.4, 1.6, 1.8, 2, 3, 4, or 5. The average cell size may be in a range provided by any two of these upper and/or lower values.

In one preferred embodiment, the nucleating agent used during the blowing of the polymer is a hydrated magnesium silicate (talc). The talc may be present in an amount between approximately 0.7 to approximately 1.2 wt. % of the polymeric foam, preferably approximately 0.8 wt. %. High aspect ratio minerals, such as talc and clays, are useful nucleating agents to nucleate the gas bubbles. Talc levels >1.0 wt. % can adversely affect foaming and foam stability, therefore, the talc levels used preferably less than 0.8%.

It will be appreciated that a blowing agent may be added to the polymer resin in any convenient manner. In an extrusion process, the blowing agent mixture is pumped into the polymeric resin and admixed therewith prior to extrusion through a die to form foam. The blowing agent may be admixed and pumped as a combination stream into the heat plastified resin, or they may be supplied as separate streams. Adequate mixing of the blowing agents into the heat plastified resin is required in order to obtain a product of desirable uniformity. Such mixing may be accomplished by a variety of means including dynamic mixers such as extruders, so-called static mixers or interfacial surface generators. For example, the blowing agent may be butane or pentane.

### Application and Use of a Backer Rod

The present disclosure may provide a method for sealing a void formed by a first and second element, wherein the first and second element may be defined by a first and second end surface, wherein the first end surface and the second end surface are opposing and adjacent to define the void, the height of the void defined by a top plane and a bottom plane, the method comprising the steps of: i) friction fitting a backer rod into the void to a depth to define a sealant collection cavity within the void; and ii) optionally applying a sealant within the sealant collection cavity to form a sealant layer; wherein the backer rod comprises a polymeric foam containing at least one insecticide substantially distributed throughout the polymeric foam, wherein the backer rod acts as a physical and chemical barrier to impede the ingress of insects into a structure, wherein the backer rod is an elongated rod that has a diameter of between about 6 mm to about 65 mm, and wherein the backer rod has a cross-sectional profile that is circular, triangular, square, rectangular or half circular.

It will be appreciated that the backer rod, as described herein, may be sized larger than the joint gap space intended for application. In an embodiment, the backer rod may be friction fitted into construction gaps and recessed to accommodate an appropriate depth of sealant for weatherproofing, insulating fire stopping, or other various purposes. The backer rod may be designed to not only provide a bond-breaking surface preventing 3 point adhesion which can limit useful life of a sealant but also to impede the ingress of insects.

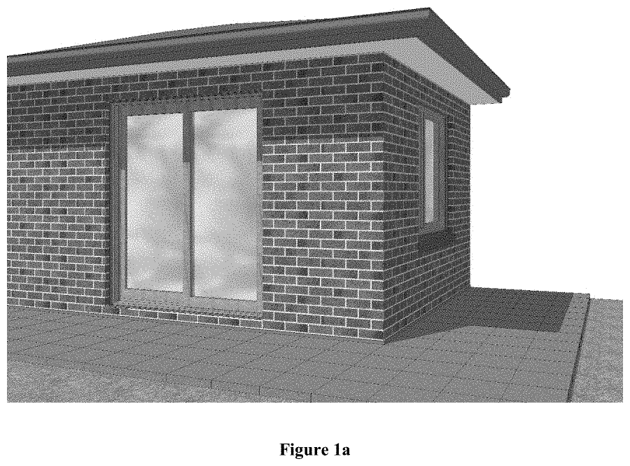

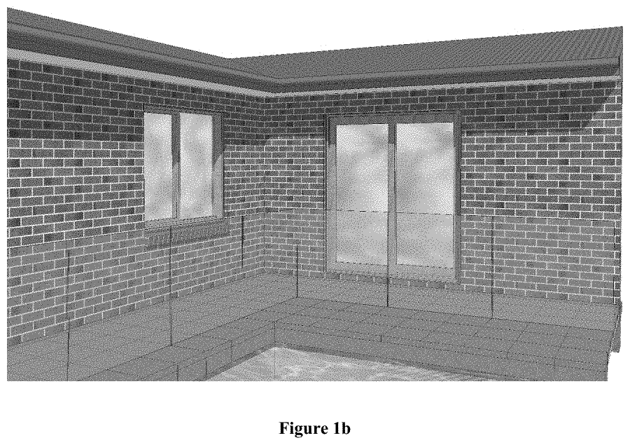

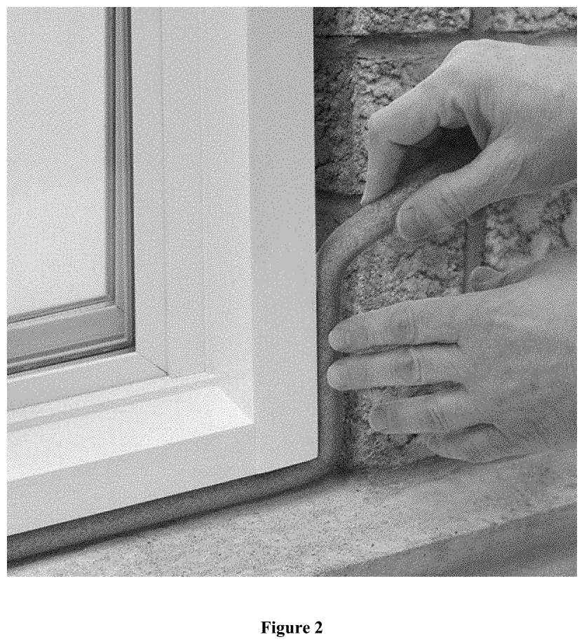

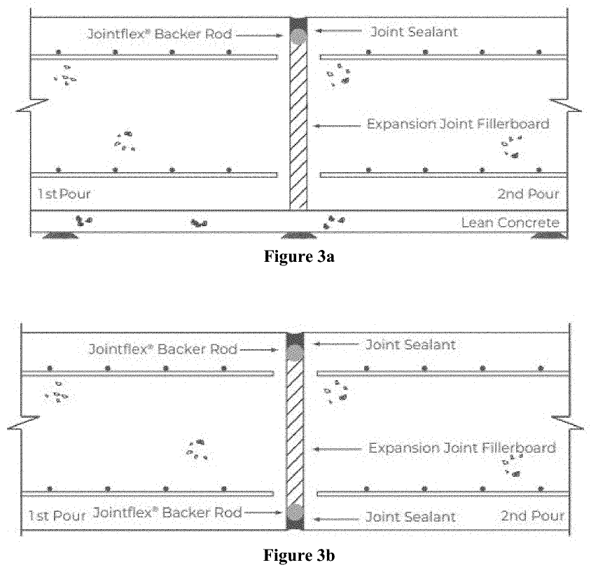

In an embodiment or example, the backer rod may serve as a depth control for a sealant while at the same time providing insulation and a physical and chemical barrier to impede the ingress of insects into a structure, e.g. a building structure or slab on the ground as shown in FIGS. 1a and 1b, FIG. 2 and FIGS. 3a and 3b. Working in conjunction with a sealant, the backer rod may be placed in joint spaces between construction assemblies and recessed to a proper sealant depth requirement. It will be appreciated that the backer rod will provide insulation in accordance with ASTM E1966 or ANSI/UL 2079.

In an embodiment, the backer rod may be constructed of a polymeric foam. The polymeric foam may be impermeable to water. In an example, the polymeric foam for the backer rod may be closed cell low density polyethylene, as described herein. When a sealant is applied within a joint and on the exterior of the backer rod, the closed celled feature may prevent 3 point adhesion of the sealant to the surface of the backer rod during application in a joint. However, it should be understood by a person skilled in the art that other suitable foams may be used in the practice of the invention.

In an embodiment, the insecticide may exhibit control or repellent affects against insects.

In some embodiment, the insecticide may be extruded within the polymeric foam. The insecticide may be selected from any one or more of the group comprising pyrethrum, synthetic pyrethroids, organo-chlorines, organo-sulfurs, carbamates, organo-phosphates, formamidines, neonicotinoids, nicotinoids, spinosyns, phenylpyrazoles, pyrroles, pyrazoles, dinitrophenols, pyridazinones, quinazolines, and benzoylureas. The insecticide may be a synthetic pyrethroid compound selected from the group comprising deltamethrin, permethrin, bifenthrin, and mixtures thereof. In a preferred example, the insecticide is bifenthrin. The concentration of the insecticide may be between about 0.2 wt. % and about 4.0 wt. %, preferably between about 0.5 wt. % and about 2.0 wt. %.

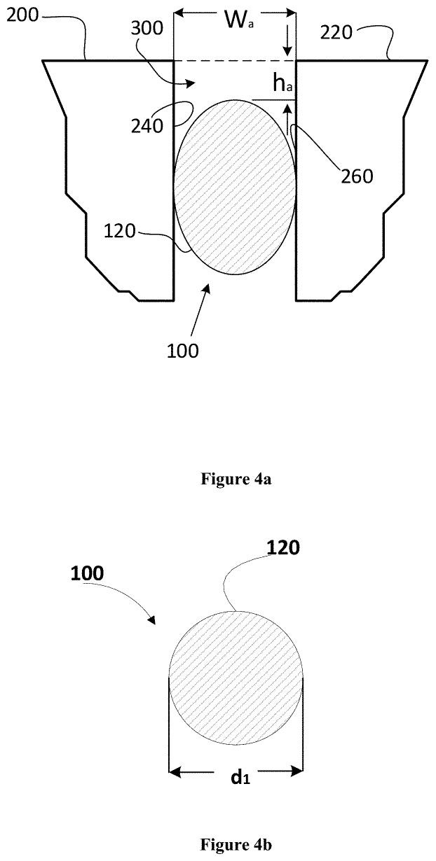

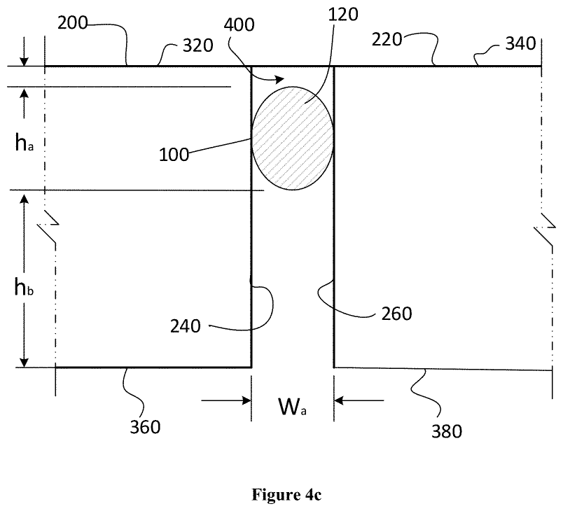

In FIG. 4a, a backer rod 100 is shown in a preferred application environment in an enlarged cross-sectional view. The backer rod 100 is shown after installation in a compressed fit between a first element 200 and a second element 220. The backer rod 100 is shown after partial installation. As shown, no sealant has been applied to form a finished joint assembly.

The first and second elements 200, 220 may be defined by a first and second end surface, wherein the first end surface 240 and the second end surface 260 are opposing and adjacent to define the void. In an embodiment, the first element 200 and the second element 220 may be composed of the same or different materials, wherein the material may be selected from any one of brick, wood, plastic, metal, concrete, or a combination thereof. In an embodiment or example, the first element 200 may be composed of concrete and the second element 220 is not composed of concrete, for example may be brick. In another embodiment or example, the first element and second elements 200, 220 may be composed of wood. The elements 200, 220 may be made of conventional building materials, such as concrete, wood, brick, plastic, metal, or a combination thereof.

As shown, a first end surface 240 of the first element 200 is opposing and adjacent a second end surface 260 of the second element 220. In this position, the end surfaces 240, 260 form a void between the elements 200, 220. The void has a width Wₐ that is not greater than the tube 120 outer diameter d₁ (see FIG. 4b). As shown, the width Wₐ is less than the tube 120 outer diameter d₁.

The backer rod 100 is installed within the void for sealant and insect control and/or repellent purposes. Still referring to FIG. 4a, the backer rod 100 is press fit (e.g. friction fitted) into the void to a depth haₐ define a sealant collection cavity 300 within the void. In FIG. 4c, the cavity 300 is shown filled with a sealant 400. Although the sealant level may vary, the sealant 400 is shown filled to a level equal to a first and second top plane 320, 340 of the first and second elements 200, 220. After sealant application, the backer rod essentially maintains a depth of haₐ the top of the tube 120, and a distance of h_{b} (see FIG. 4c) from the bottom of the tube 120 to a first and second bottom plane 360, 380 of the first and second elements 200, 220.

Once cured, the sealant layer forms a bond between the backer rod 100 and the first end surface 240, the backer rod 100 and the second end surface 260, and the first end surface 240 and the second end surface 260.

The present disclosure may be described by the following embodiments:

1. A backer rod for sealing a void formed by a first and second element, wherein the first and second element is defined by a first and second end surface, wherein the first end surface and the second end surface are opposing and adjacent to define the void, the height of the void defined by a top plane and a bottom plane, the backer rod comprising a polymeric foam containing at least one insecticide in an effective amount and substantially distributed throughout the polymeric foam, wherein the backer rod acts as a physical and chemical barrier to impede the ingress of insects into a structure, wherein the backer rod is an elongated rod that has a diameter of between about 6 mm to about 65 mm, and wherein the backer rod has a cross-sectional profile that is circular, triangular, square, rectangular or half circular.
2. The backer rod according to any one or more embodiments described herein, wherein the insecticide exhibits control or repellent affects against insects.
3. The backer rod according to any one or more embodiments described herein, wherein the insect is not a termite.
4. The backer rod according to any one or more embodiments described herein, wherein the backer rod forms a fire resistant barrier.
5. The backer rod according to any one or more embodiments described herein, wherein the insecticide is extruded with the polymeric foam.
6. The backer rod according to any one or more embodiments described herein, wherein the insecticide is selected from any one or more of the group comprising pyrethrum, synthetic pyrethroids, organo-chlorines, organo-sulfurs, carbamates, organo-phosphates, formamidines, neonicotinoids, nicotinoids, spinosyns, phenylpyrazoles, pyrroles, pyrazoles, dinitrophenols, pyridazinones, quinazolines, and benzoylureas.
7. The backer rod according to any one or more embodiments described herein, wherein the insecticide is a synthetic pyrethroid compound selected from the group comprising deltamethrin, permethrin, bifenthrin, and mixtures thereof.
8. The backer rod according to any one or more embodiments described herein, wherein the insecticide is bifenthrin.
9. The backer rod according to any one or more embodiments described herein, wherein the concentration of the insecticide is between about 0.2 wt. %, and about 4.0 wt. %, preferably between about 0.5 wt. % and about 2.0 wt. %.
10. The backer rod according to any one or more embodiments described herein, wherein the polymeric foam is a closed cell polymeric foam.
11. The back rod according to any one or more embodiments described herein, wherein the polymeric foam has a cell size of about 0.5 mm to about 2 mm.
12. The backer rod according to any one or more embodiments described herein, wherein the polymeric foam is manufactured at a temperature of less than 180° C. and is prepared primarily from a blend of a crosslinked polyethylene and a low melting ethylene-vinyl acetate (EVA) copolymer.
13. The backer rod according to any one or more embodiments described herein, wherein the crosslinked polyethylene is a crosslinked linear low density polyethylene (LLDPE).
14. The backer rod according to any one or more embodiments described herein, wherein the polymeric foam is a composite comprising crosslinked LLDPE and low melting EVA polymer.
15. The backer rod according to any one or more embodiments described herein, wherein a stabilizer is present in an amount between 0.1 wt. % and about 10 wt. % and the stabilizers is selected from the group comprising inorganic silicate, silicone dioxide, hydrophobic silicone dioxide, montmorillonite clay, sodium bentonite clay with high montmorillonite content, magnesium aluminium silicate and aluminium silicate.
16. The backer rod according to any one or more embodiments described herein, wherein the polymeric foam further comprises one more additives selected from the group comprising inorganic fillers, pigments, lubricants, stabilizers, antioxidants, antifungal agents, acid scavengers, ultraviolet absorbers, flame retardants, processing aids, dispersion aids, extrusion aids, and the like.
17. The backer rod according to any one or more embodiments described herein, wherein the polymeric foam comprises a stabilizer and the stabilizer is kaolin.
18. The backer rod according to any one or more embodiments described herein, wherein the polymeric foam includes a UV stabilizer.
19. The backer rod according to any one or more embodiments described herein, wherein the polymeric foam has a density of between about 20 kg/m³ and about 60 kg/m³.
20. A method for sealing a void formed by a first and second element, wherein the first and second element is defined by a first and second end surface, wherein the first end surface and the second end surface are opposing and adjacent to define the void, the height of the void defined by a top plane and a bottom plane, the method comprising the steps of:

i) friction fitting a backer rod into the void to a depth to define a sealant collection cavity within the void; and

ii) optionally applying a sealant within the sealant collection cavity to form a sealant layer;

wherein the backer rod comprises a polymeric foam containing at least one insecticide substantially distributed throughout the polymeric foam, wherein the backer rod acts as a physical and chemical barrier to impede the ingress of insects into a structure, wherein the backer rod is an elongated rod that has a diameter of between about 6 mm to about 65 mm, and wherein the backer rod has a cross-sectional profile that is circular, triangular, square, rectangular or half circular.

21. The method according to any one or more embodiments described herein, wherein the first element and the second element are composed of the same or different materials, wherein the material may be selected from any one of brick, wood, plastic, metal, concrete, or a combination thereof, wherein when the first element is composed of concrete, the second element is not composed of concrete.
22. The method according to any one or more embodiments described herein, wherein the sealant layer forms a bond between the backer rod and the first end surface, the between backer rod and the second end surface, and between the first end surface and the second end surface.
23. The method according to any one or more embodiments described herein, wherein the insecticide exhibits control or repellent affects against insects.
24. The method according to any one or more embodiments described herein, wherein the insect is not a termite.
25. The method according to any one or more embodiments described herein, wherein the backer rod forms a fire resistant barrier.
26. The method according to any one or more embodiments described herein, wherein the insecticide is impregnated into the polymeric foam.
27. The method according to any one or more embodiments described herein, wherein the insecticide is selected from any one or more of the group comprising pyrethrum, synthetic pyrethroids, organo-chlorines, organo-sulfurs, carbamates, organo-phosphates, formamidines, neonicotinoids, nicotinoids, spinosyns, phenylpyrazoles, pyrroles, pyrazoles, dinitrophenols, pyridazinones, quinazolines, and benzoylureas.
28. The method according to any one or more embodiments described herein, wherein the insecticide is a synthetic pyrethroid compound selected from the group comprising deltamethrin, permethrin, bifenthrin, and mixtures thereof.
29. The method according to any one or more embodiments described herein, wherein the insecticide is bifenthrin.
30. The method according to any one or more embodiments described herein, wherein the concentration of the insecticide is between about 0.2 wt. % and about 4.0 wt. %, preferably between about 0.5 wt. % and about 2.0 wt. %.
31. The method according to any one or more embodiments described herein, wherein the polymeric foam is a closed cell polymeric foam.
32. The method according to any one or more embodiments described herein, wherein the polymeric foam has a cell size of about 0.5 mm to 2 mm.
33. The method according to any one or more embodiments described herein, wherein the polymeric foam has a density of between about 10 kg/m³ and about 60 kg/m³.

### EXAMPLES

The present disclosure will now be described with reference to the following non-limiting examples and with reference to the accompanying Figures.

### Example 1 Field Study to Determine the Repellency of Two Rates of Bifenthrin Treated Foam Against a Black Ant

Active nests or trails of black ants were selected in gardens in the southern suburbs of Sydney, NSW, Australia.

Backer rod sample comprising 0.5% w/w Bifenthrin was cut using a scalpel blade to 5 mm width×20 mm long×10 mm thick strips. These were glued to the top outside edge of a white 200 mm×200 mm glazed tile using contact adhesive. This produced a foam barrier 10 mm thick & 5 mm wide as a continuous barrier on the tile. There were five repeats of the same backer rod samples adhered to 200 mm×200 mm tiles, as above.

A further backer rod sample comprising 0.2% w/w Bifenthrin was cut using a scalpel blade to 5 mm width×20 mm long×10 mm thick strips. These were glued to the top outside edge of a white 200 mm×200 mm glazed tile using contact adhesive. This produced a foam barrier 10 mm thick and 5 mm wide as a continuous barrier on the tile. There were five repeats of the same backer rod samples adhered to 200 mm×200 mm tiles, as above.

An identical tile was set up as an untreated control, i.e. a backer rod sample comprising no bifenthrin was cut using a scalpel blade to 5 mm width×20 mm long×10 mm thick strips and glued to the top outside edge of a white 200 mm×200 mm glazed tile using contact adhesive.

Two grams of thinly sliced ham was placed into the middle of each of the tiles. In order for an ant to reach the ham, it had to cross the backer rod.

The tile with the backer rod treated with bifenthrin were set up on one side of a black ant trail or nest and the other tile with the control backer rod was set up the same distance from the ant trial or nest on the opposite side.

The samples were left for 60 minutes and the number of ants on each of the foam samples was counted at 15, 30 and 60 minutes after placement. This was repeated a total of 5 times each with the replicates. The orientation of the treated tiles and the control tiles to the ant nest or trail was randomized.

The following Table 1 provides percent repellency of each of the active treatments. The percentage repellency was calculated by the following Equation I:

$$Percentage repellency = 1 - \frac{Number of ants on treated tile}{Number of ants on control tile} \times 100$$

TABLE 1
Summary table - the percentage repellency of treated backer rod

% repellency of treated backer rod at
various exposure time

| | 15 minutes | 30 minutes | 60 minutes |
|---|---|---|---|
| 0.5% bifenthrin | 16.0 | 37.8 | 37.4 |
| 0.2% bifenthrin | 16.4 | 23.6 | 36.1 |

### Example 2 Laboratory Study to Compare the Repellency of Two Rates of Bifenthrin Treated Foam Against the American Cockroach

50 American cockroaches, 15 adults and 35 mixed age nymphs, were introduced into a large round white plastic tub, 600 mm in diameter and 450 mm high sides. The upper part of the wall of the tub was coated with Fluon AD1 to prevent the cockroaches from escaping. The cockroaches were left undisturbed for 24 hours to acclimate. A total of 15 tubs were set up, as above.

A backer rod sample comprising 0.5% w/w bifenthrin was cut using a scalpel blade to 5 mm width×20 mm long×10 mm thick strips. The strips were glued to the top outside edge of a white 200 mm×200 mm glazed tile using contact adhesive. This produced a foam barrier 10 mm thick & 5 mm wide as a continuous barrier on the tile. There were 5 repeats of the same backer rod samples adhered to 200 mm×200 mm tiles, as above.

A further backer rod sample comprising 0.2% w/w bifenthrin was cut using a scalpel blade to 5 mm width×20 mm long×10 mm thick strips. The strips were glued to the top outside edge of a white 200 mm×200 mm glazed tile using contact adhesive. This produced a foam barrier 10 mm thick and 5 mm wide as a continuous barrier on the tile. There were 5 repeats of the same backer rod samples adhered to 200 mm×200 mm tiles, as above.

An identical tile was set up as an untreated control, i.e. a backer rod sample comprising no bifenthrin was cut using a scalpel blade to 5 mm width×20 mm long×10 mm thick strips and glued to the top outside edge of a white 200 mm×200 mm glazed tile using contact adhesive. There were 20 repeats of the same backer rod samples adhered to 200 mm×200 mm tiles, as above.

A tile with the backer rod treated with bifenthrin and a tile with the control backer rod were placed in a tub with the acclimatised cockroaches. The orientation of the treated foam tiles and the control tiles were randomized. There were five repeats for both the 0.5% w/w and 0.2% w/w bifenthrin backer rod edged tiles.

Two tiles with the control backer rod were placed in a tub with the acclimatised cockroaches. The orientation of the control tiles were randomized. There were five repeats of the two control tile tubs.

A square of Cadbury Dairy Milk chocolate was placed into the middle of each of the tiles. The chocolate had previously been weighed using a 4-place analytical balance. There was no food (other than the chocolate squares described above) provided.

At 24, 48 & 120 hours post tile introduction, the chocolate was weighed to determine the amount consumed.

At 120 hours post treatment the number of dead cockroaches in each tub was noted.

TABLE 2
Summary table - the total weight of chocolate
removed - 0.5% w/w bifenthrin

| | | | | | | Total |
|---|---|---|---|---|---|---|
| | | | | | | Number |
| | Weight of chocolate removed | | | | Percent- | of Dead |
| Treat- | from tile (g) | | | | age | Cock- |
| ment | 24 hrs | 48 hrs | 120 hrs | Total | Removed | roaches |
| 0.5% | 0.9761 | 0.2340 | 0.4650 | 1.6751 | 47.0 | 8 |
| bifenthrin | | | | | | |
| Control | 0.9218 | 0.1931 | 0.7738 | 1.8887 | 53.0 | |

TABLE 3
Summary table - the total weight of chocolate
removed - 0.2% w/w bifenthrin

| | | | | | | Total |
|---|---|---|---|---|---|---|
| | | | | | | Number |
| | Weight of chocolate removed | | | | Percent- | of Dead |
| Treat- | from tile (g) | | | | age | Cock- |
| ment | 24 hrs | 48 hrs | 120 hrs | Total | Removed | roaches |
| 0.5% | 0.4582 | 0.2664 | 0.7031 | 1.4277 | 53.2 | 9 |
| bifenthrin | | | | | | |
| Control | 0.3847 | 0.2785 | 0.5915 | 1.2547 | 46.8 | |

TABLE 4
Summary table - the total weight of chocolate removed - control

| | | | | | | Total |
|---|---|---|---|---|---|---|
| | | | | | | Number |
| | Weight of chocolate removed | | | | Percent- | of Dead |
| Treat- | from tile (g) | | | | age | Cock- |
| ment | 24 hrs | 48 hrs | 120 hrs | Total | Removed | roaches |
| Control | 0.3018 | 0.3054 | 0.4489 | 1.0561 | 46.5 | 7 |
| Control | 0.3159 | 0.4696 | 0.4387 | 1.2242 | 53.5 | |

### Example 3 Laboratory Study to Compare the Efficacy of Bifenthrin Treated Foam Against the American Cockroach

A 200 mm×200 mm foam tile was cut from 2% w/w Bifenthrin foam to provide material for bioassays.

Five adult and five mid-instar American cockroach nymphs were placed in a plastic container (base diameter 15 cm and height 10 cm) treated with fluon along the walls.

The container was upturned, such that the 10 cockroaches were constantly in contact with the foam for the desired exposure time. The container was held stationary and the cockroaches were allowed to move within the confines of the container. This process was repeated five times, with a new set of 10 cockroaches for each repetition, for each of the exposure times: 10, 60, 300 and 600 seconds.

Knockdown, defined as a cockroach being on their back with legs twitching in large movements, was noted at 1, 3, and 24 hours after exposure.

Mortality, defined as no obvious movement before or after being touched by small paintbrush, was noted at 24 hours after exposure.

A second 200 mm×200 mm foam tile was cut from control foam comprising no bifenthrin.

Five adult and five mid-instar American cockroach nymphs were placed in a plastic container (base diameter 15 cm and height 10 cm) treated with fluon along the walls.

The container was upturned, such that the 10 cockroaches were constantly in contact with the foam for the desired exposure time. The container was held stationary and the cockroaches were allowed to move within the confines of the container. This process was repeated five times, with a new set of 10 cockroaches for each repetition, for each of the exposure times: 10, 60, 300, 600 and 3600 seconds.

Knockdown, defined as a cockroach being on their back with legs twitching in large movements, was noted at 1, 3, and 24 hours after exposure.

Mortality, defined as no obvious movement before or after being touched by small paintbrush, was noted at 24 hours after exposure.

TABLE 5
Summary table - The Knockdown and Mortality of American
Cockroaches on foam surfaces after Various exposure times

| | | The Percentage Knockdown (KD) & Mortality at | | | | |
|---|---|---|---|---|---|---|
| | | Various Times Post Exposure | | | | |
| | Exposure | 1 Hour | 3 Hours | 24 Hours | | |
| Treatment | Time (s) | KD | KD | KD | Mortality | Total |
| 2% | 10 | 92 | 100 | 0 | 100 | 100 |
| bifenthrin | 60 | 94 | 100 | 0 | 100 | 100 |
| | 300 | 100 | 100 | 0 | 100 | 100 |
| | 600 | 100 | 100 | 2 | 98 | 100 |
| Control | 10 | 0 | 0 | 0 | 0 | 0 |
| Foam | 60 | 0 | 0 | 0 | 2 | 2 |
| | 300 | 0 | 0 | 0 | 0 | 0 |
| | 600 | 0 | 0 | 0 | 0 | 0 |
| | 3600 | 0 | 0 | 0 | 2 | 2 |

1. A backer rod for sealing a void formed by a first and second element, wherein the first and second element is defined by a first and second end surface, wherein the first end surface and the second end surface are opposing and adjacent to define the void, the height of the void defined by a top plane and a bottom plane, the backer rod comprising a polymeric foam containing at least one insecticide in an effective amount and substantially distributed throughout the polymeric foam, wherein the backer rod acts as a physical and chemical barrier to impede the ingress of insects into a structure, wherein the backer rod is an elongated rod that has a diameter of between about 6 mm to about 65 mm, and wherein the backer rod has a cross-sectional profile that is circular, triangular, square, rectangular or half circular.

2. The backer rod according to claim 1, wherein the insecticide exhibits control or repellent affects against insects.

3. The backer rod according to claim 1, wherein the insect is not a termite.

4. The backer rod according to claim 1, wherein the backer rod forms a fire resistant barrier.

5. The backer rod according to claim 1, wherein the insecticide is extruded with the polymeric foam.

6. The backer rod according to claim 1, wherein the insecticide is selected from any one or more of the group comprising pyrethrum, synthetic pyrethroids, organo-chlorines, organo-sulfurs, carbamates, organo-phosphates, formamidines, neonicotinoids, nicotinoids, spinosyns, phenylpyrazoles, pyrroles, pyrazoles, dinitrophenols, pyridazinones, quinazolines, and benzoylureas.

7. The backer rod according to claim 1, wherein the insecticide is a synthetic pyrethroid compound selected from the group comprising deltamethrin, permethrin, bifenthrin, and mixtures thereof.

8. The backer rod according to claim 1, wherein the polymeric foam is a closed cell polymeric foam.

9. The backer rod according to claim 1, wherein the concentration of the insecticide is between about 0.2 wt. %, and about 4.0 wt. %, preferably between about 0.5 wt. % and about 2.0 wt. %.

10. The backer rod according to claim 1, wherein the polymeric foam is a closed cell polymeric foam.

11. The backer rod according to claim 1, wherein the polymeric foam is manufactured at a temperature of less than 180° C. and is prepared primarily from a blend of a crosslinked polyethylene and a low melting ethylene-vinyl acetate (EVA) copolymer.

12. The backer rod according to claim 1, wherein the polymeric foam is manufactured at a temperature of less than 180° C. and is prepared primarily from a blend of a crosslinked polyethylene and a low melting ethylene-vinyl acetate (EVA) copolymer.

13. The backer rod according to claim 1, wherein the crosslinked polyethylene is a crosslinked linear low density polyethylene (LLDPE).

14. The backer rod according to claim 1, wherein the polymeric foam is a composite comprising crosslinked LLDPE and low melting EVA polymer and/or wherein the polymeric foam has a density of between about 20 kg/m³ and about 60 kg/m³.

15. The backer rod according to claim 1, wherein a stabilizer is present in an amount between 0.1 wt. % and about 10 wt. % and the stabilizers is selected from the group comprising inorganic silicate, silicone dioxide, hydrophobic silicone dioxide, montmorillonite clay, sodium bentonite clay with high montmorillonite content, magnesium aluminium silicate and aluminium silicate.

16. The backer rod according to claim 1, wherein the polymeric foam further comprises one more additives selected from the group comprising inorganic fillers, pigments, lubricants, stabilizers, antioxidants, antifungal agents, acid scavengers, ultraviolet absorbers, flame retardants, processing aids, dispersion aids, extrusion aids, and the like.

17. The backer rod according to claim 1, wherein the polymeric foam comprises a stabilizer and the stabilizer is kaolin.

18. The backer rod according to claim 1, wherein the polymeric foam includes a UV stabilizer.

19. A method for sealing a void formed by a first and second element, wherein the first and second element is defined by a first and second end surface, wherein the first end surface and the second end surface are opposing and adjacent to define the void, the height of the void defined by a top plane and a bottom plane, the method comprising the steps of:
i) friction fitting a backer rod into the void to a depth to define a sealant collection cavity within the void; and
ii) optionally applying a sealant within the sealant collection cavity to form a sealant layer;
wherein the backer rod comprises a polymeric foam containing at least one insecticide substantially distributed throughout the polymeric foam, wherein the backer rod acts as a physical and chemical barrier to impede the ingress of insects into a structure, wherein the backer rod is an elongated rod that has a diameter of between about 6 mm to about 65 mm, and wherein the backer rod has a cross-sectional profile that is circular, triangular, square, rectangular or half circular.

20. The method according to claim 19, wherein the first element and the second element are composed of the same or different materials, wherein the material may be selected from any one of brick, wood, plastic, metal, concrete, or a combination thereof, wherein when the first element is composed of concrete, the second element is not composed of concrete.

21. The method according to claim 20, wherein the sealant layer forms a bond between the backer rod and the first end surface, the between backer rod and the second end surface, and between the first end surface and the second end surface.
